(19) United States
(12) Patent Application Publication
(10) Pub. No.: US 2025/0043998 A1
(43) Pub. Date: Feb. 6, 2025

(54) APPARATUSES, SYSTEMS, AND METHODS FOR STORING AND TRANSPORTING A TEMPERATURE SENSITIVE MATERIAL

(71) Applicant: Kite Pharma, Inc., Foster City, CA (US)

(72) Inventors: Frank D. Obrad, Mansfield, TX (US); Brian A. Wallin, Nashua, IA (US)

(21) Appl. No.: 18/792,121

(22) Filed: Aug. 1, 2024

Related U.S. Application Data
(60) Provisional application No. 63/517,746, filed on Aug. 4, 2023.

(51) Int. Cl. F25B 21/02; F25D 11/00

(52) U.S. Cl. CPC F25B 21/02; F25D 11/003

(57) ABSTRACT

The present disclosure describes storing and transporting technologies for temperature sensitive materials. More specifically, storage and transport of apheresis material. The described technologies include environmental monitoring systems, location tracking systems, an environmental control system, and customized systems and interfaces allowing for non-expert use. The storing and transporting technologies described herein may be ideally suited for the unique requirements of apheresis material.

### CROSS-REFERENCES TO RELATED APPLICATIONS

This application claims the benefit of priority to U.S. Provisional Patent Application No. 63/517,746, filed on Aug. 4, 2023, the entirety of which is incorporated by reference herein.

### FIELD OF THE INVENTION

The present disclosure generally relates to apparatuses, systems, and methods for transporting a temperature sensitive material. More specifically, an apheresis material. Moreover, the disclosure relates to a system capable of environmentally controlling and monitoring a closed container for storing a temperature sensitive material such as an apheresis material during transport from a collection site to a processing facility.

### BACKGROUND

As the medical and biopharma industries have grown, so has the demand for storing and transporting temperature sensitive materials such as apheresis material. The currently existing technical solutions borrow from other mature industries and are, unfortunately, not suitable for optimal storing and transporting apheresis material. Due the sensitive and complicated nature of many cell therapy processes, the design requirements on storing and transporting technologies are unique. For example, temperatures need to be kept within narrow margins and non-experts need to be able to set-up and operate the storage and shipping systems. Also, due to the value of the material being transported, control and monitoring systems are needed to reduce failure rates.

Often apheresis material is taken from patients at hospitals or clinical sites and, optionally, the apheresis material may be sent to a collection and shipping facility before transport to a manufacturing site occurs. As such, storage and shipping systems need to be easy to operate by hospital, clinical staff, and/or staff at a collection and shipping facility. One of the difficulties of currently existing storage and shipping systems is that they often need to be pre-conditioned. As such, the hospital and/or clinical staff must understand the pre-conditioning operations of the storage and shipping systems. It is also important that storage and shipping systems are reliable due to the value of the contents they carry. Reliability needs to be ensured for both short, medium, and long-distance travel. The currently available storage and shipping technologies lack in all these ways.

Further, storing and transporting technologies need to be able to transport a temperature sensitive material great distances within a predetermined temperature range. There are also market demands for features such as on-demand location and sample condition tracking. For example, real time tracking of temperature may lead to the preservation of a sample or immediate removal of the candidate which results in a more efficient use of time. The currently available storing and transporting technologies lack in these and other ways.

Evaporative on-demand cooling shippers may be stored until the patient is ready to donate a sample. Unfortunately, the design of currently available evaporative on-demand cooling shippers leads to high failure rates. Additionally, evaporative on-demand cooling shippers occasionally do not maintain the required temperature ranges. The performance between individual shippers may vary making it difficult to ensure patient samples remain viable. These and other performance issues may be exacerbated by increased travel distances.

Existing vacuum insulated shippers using phase change material or ice for cooling may have lower failure rates than evaporative cooling shippers, but lack in many other critical features such as on-demand availability due to preconditioning requirements. Additionally, existing vacuum insulated shippers typically lack other important safety features such as location tracking. Existing vacuum insulated shippers require advanced preparation and often lead to logistical errors and damaged donor samples.

As such, there is a need for reliable environmental control systems capable of staying active for long periods of time, sample condition and location monitoring systems allowing for sample retrieval in the event of an emergency, etc. The apparatuses, systems, and methods described herein provide for these and other needs.

### SUMMARY

In various aspects, a system for transporting a temperature sensitive material is described. In various embodiments, a shipping container may comprise a housing surrounding a cavity and a lid for sealing the cavity. In various embodiments, the system may comprise a storage container sized to reside within the cavity. In various embodiments, the storage container may comprise a housing enclosing an internal cavity, wherein the housing includes an exterior wall joined to an interior wall forming a vacuum therebetween. In various embodiments, the storage container may comprise an insert sized to fit within the internal cavity.

In various embodiments, the insert comprises phase change material. In various embodiments, the insert may comprise a first end joined to a second end by a wall and an opening extending across the first end and extending toward the second end to form a wedge shape designed for receiving a bag suitable for containing a temperature sensitive material.

In various embodiments, the system may comprise a chill plate in thermal contact with the insert.

In various embodiments, the system may comprise at least one thermal electric cooler in thermal contact with the chill plate.

In various embodiments, the system may comprise a heat sink in thermal contact with the at least one thermal electric cooler.

In various embodiments, the system may comprise a heat exchanger in thermal contact with the heat sink. In various embodiments, the heat exchanger may comprise a housing surrounding a hollow portion, an inlet extending away from the housing and providing access to the hollow portion, and an outlet extending away from the housing and providing access to the hollow portion.

In various embodiments, the system may comprise a mounting bracket. In various embodiments, the mounting bracket may comprise a planar element including a top surface joined to a bottom surface by an exterior wall and an interior wall, wherein the interior wall surrounds an opening and wherein the heat exchanger is positioned within the opening.

In various embodiments, the system may comprise a first set of attachment elements securing the mounting bracket to the heat sink and a second set of attachment elements securing the heat exchanger to the mounting bracket.

In various embodiments, the system may comprise a radiator thermally coupled to the heat exchanger. In various embodiments, the radiator may comprise an inlet, an outlet connected to the inlet by a flow channel, and fins positioned within thermal proximity to an exterior surface of the flow channel, wherein a first fluid channel fluidically connects the inlet of the radiator to the outlet of the heat exchanger, wherein a second fluid channel fluidically connects the outlet of the radiator to the inlet of the heat exchanger.

In various embodiments, the system may comprise fans. In various embodiments, the fans may be positioned adjacent to the fins.

In various embodiments, the system may comprise a pump positioned along one of the flow channels of the radiator.

In various embodiments, the system may comprise a control system. In various embodiments, the computer system may comprise a controller in electronic communication with a power supply, wherein the power supply provides electricity to the at least one thermal electric cooler and a sensor in electronic communication with the controller, wherein the sensor is thermally coupled to the phase change material.

In various embodiments, the system may comprise an environmental condition monitoring system. In various embodiments, the environmental conditional monitoring system may comprise a data logger and a sensor.

In various embodiments, the sensor may include a thermocouple in physical contact with the phase change material.

In various embodiments, the data logger may include a data transmitter.

In various embodiments, the controller and the data logger may be in electronic communication.

In various embodiments, the controller may include a user interface.

In various embodiments, the control system may comprise an on/off button.

In various embodiments, the housing of the shipping container further comprises vents for dissipating heat from the radiator to an external environment.

In various embodiments, thermal contact may be facilitated by use of thermal paste as an intermediary material.

In various embodiments, the temperature sensitive material comprises an apheresis material.

### BRIEF DESCRIPTION OF THE FIGURES

FIG. 1 illustrates a system for transporting a temperature sensitive material in accordance with various embodiments.

FIG. 2 illustrates a shipping system for a transporting a temperature sensitive material, in accordance with various embodiments.

FIG. 3 illustrates a system for transporting a temperature sensitive material in accordance with various embodiments.

FIG. 4 is a schematic diagram of a heat transfer system for a shipping system for transporting a temperature sensitive material, in accordance with various embodiments.

FIG. 5 illustrates an exploded view of components of a heat transfer system for a shipping system for transporting a temperature sensitive material, in accordance with various embodiments.

FIG. 6 shows a portion of a heat transfer system having fluid channels, in accordance with various embodiments.

FIG. 7 shows a radiator for a heat transfer system, in accordance with various embodiments.

FIG. 8 shows a heat exchanger mounted to a heat sink, in accordance with various embodiments.

FIG. 9 shows a bag for transporting a temperature sensitive material, in accordance with various embodiments.

FIG. 10 illustrates a computer system for a system for transporting a temperature sensitive material, in accordance with various embodiments.

### DETAILED DESCRIPTION OF CERTAIN EMBODIMENTS

The present disclosure, among other things, provides insights and technologies useful in collection, storage, and transportation of biological materials. More specifically, the embodiments described herein may be useful in the life sciences and pharmaceutical industries to ensure patient apheresis samples can be maintained at optimal environmental conditions between the time of collection and the time of processing. For example, an apheresis material may be collected at a clinical setting (e.g., a hospital) and transported to a facility where the apheresis material can be processed. The apparatuses, systems, and methods described herein facilitate collection, storage, and/or transport of the apheresis material while environmental conditions may be controlled and monitored.

Embodiments of systems, apparatuses, and methods for environmentally controlling and monitoring apheresis material are described in the accompanying description and figures. In the figures, numerous specific details are set forth to provide a thorough understanding of certain embodiments. A skilled artisan will appreciate that the systems and methods described herein may be used in a variety of ways and circumstances that are not limited to what is specifically detailed. Additionally, the skilled artisan will appreciate that certain embodiments may be practiced without these specific details. Furthermore, one skilled in the art can readily appreciate that the specific sequences in which methods are presented and performed are illustrative and it is contemplated that the sequences can be varied and still remain within the spirit and scope of certain embodiments.

While the present teachings are described in conjunction with various embodiments, it is not intended that the present teachings be limited to such embodiments. On the contrary, the present teachings encompass various alternatives, modifications, and equivalents, as will be appreciated by those skilled in the art.

### I. Definitions

In order that the present disclosure may be more readily understood, certain terms are first defined. As used in this application, except as otherwise expressly provided herein, each of the following terms shall have the meaning set forth below. Additional definitions are set forth throughout the application. The headings provided herein are not limitations of the various aspects of the disclosure, which aspects should be understood by reference to the specification as a whole.

It is understood that, wherever aspects are described herein with the language “comprising,” otherwise analogous aspects described in terms of “consisting of” and/or “consisting essentially of” are also provided.

As used herein, the term the terms “a” and “an” are used per standard convention and mean one or more, unless context dictates otherwise.

As described herein, any concentration range, percentage range, ratio range or integer range is to be understood to be inclusive of the value of any integer within the recited range and, when appropriate, fractions thereof (such as one-tenth and one-hundredth of an integer), unless otherwise indicated.

As used herein, the term “and/or” is to be understood as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or,” as used in a phrase such as ‘A, B, and/or C’” is intended to encompass each of the following aspects: A, B, and C; A, B, or C; A or C; A or B; B or C; A and C; A and B; B and C; A (alone); B (alone); and C (alone).

As used herein, the term the use of the alternative (e.g., “or”) should be understood to mean either one, both, or any combination thereof of the alternatives.

As used herein, the term “apheresis material” means the resulting material after it has been removed from the blood of a patient. Examples of an apheresis material may include platelets, white blood cells, or any constituent of blood. In more specific examples, T cells may be collected from patients for later processing (e.g., T cell modification). An apheresis material may be temperature sensitive.

As used herein, the term “patient” means any human who is being treated for an abnormal physiological condition, such as cancer or has been formally diagnosed with a disorder, those without formally recognized disorders, those receiving medical attention, those at risk of developing the disorders, etc. The terms “subject” and “patient” may be used interchangeably herein and include both human and non-human animal subjects.

As used herein, the term, “phase change material” means a substance which releases/absorbs enough energy at a phase transition to provide useful heat or cooling for a given application (e.g., storage and transport of temperature sensitive materials such as an apheresis material). A common example of a phase change material is water; however, various additives or other compounds are commercially available allowing for customization of a set of properties of a phase change material.

As used herein, the term, “temperature sensitive material” means any material may undergo a change within a short period of time if kept at a suboptimal preservation temperature. Many processes may occur such as oxidation, growth of microorganisms, protein degradation, etc. In some cases, a change may mean rendering the temperature sensitive material unsuitable for an intended application. Examples of temperature sensitive materials include food intended for consumption, seeds, whole blood, apheresis, and other biological materials. Examples of biological materials include blood, tissue, apheresis material, material originating from a patient, engineered material originating from a patient, etc. For some temperature sensitive materials, a short period of time may be measured in minutes or hours. For other temperature sensitive materials, a short period of time may include more than a day. The various embodiments of the technologies described herein include custom design features for preserving an apheresis material. Apheresis material is even more susceptible to temperature fluctuations than other examples listed herein and, as such, must comply with strict regulations depending on the intended application. As such, the apparatuses, systems, and methods may be well adapted to facilitate a temperature-controlled transport of any temperature sensitive material (e.g., food, beverage, etc.) and especially well-suited for temperature sensitive materials that need to be confirmed to have been kept in a narrow and/or specific temperature range.

### II. Exemplary Systems

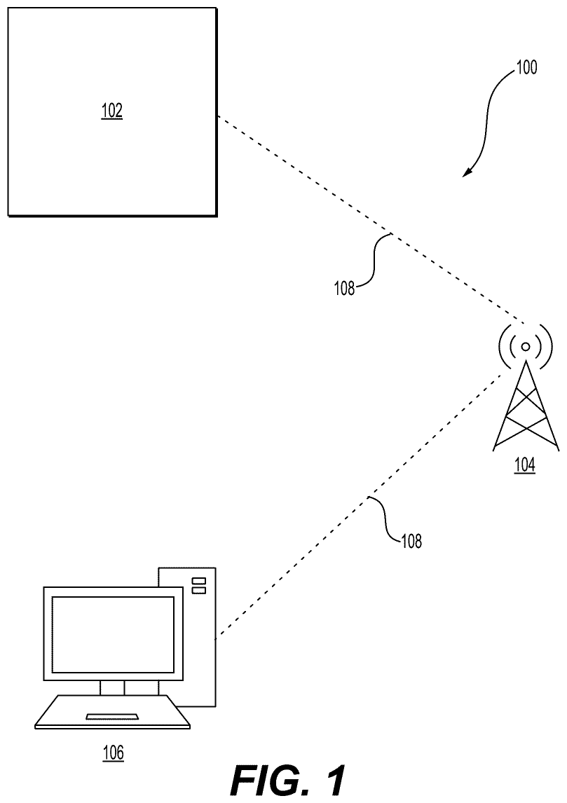

FIG. 1 illustrates a system for transporting a temperature sensitive material 100 in accordance with various embodiments. In various embodiments, the system for transporting apheresis material 100 may comprise a shipping system 102 and a computing device 106 in electronic communication through a network 108. In various embodiments, a communications relay 104 may relay an electronic communication between the shipping system 102 and the computer device 106.

In various embodiments, the communications relay 104 may be responsible for sending and receiving messages relating to the location and environmental parameters of the shipping system 102 to the computing device 106. In various embodiments, a user may transmit instructions to the shipping system 102 over the communications relay 104. In various embodiments, the communications relay 104 may comprise a cellular network including communications towers and/or satellites.

In various embodiments, the computer device 106 may comprise a desktop or laptop computer. In various embodiments, the computer device 106 may comprise a smart phone. In various embodiments, the computer device 106 may comprise a server.

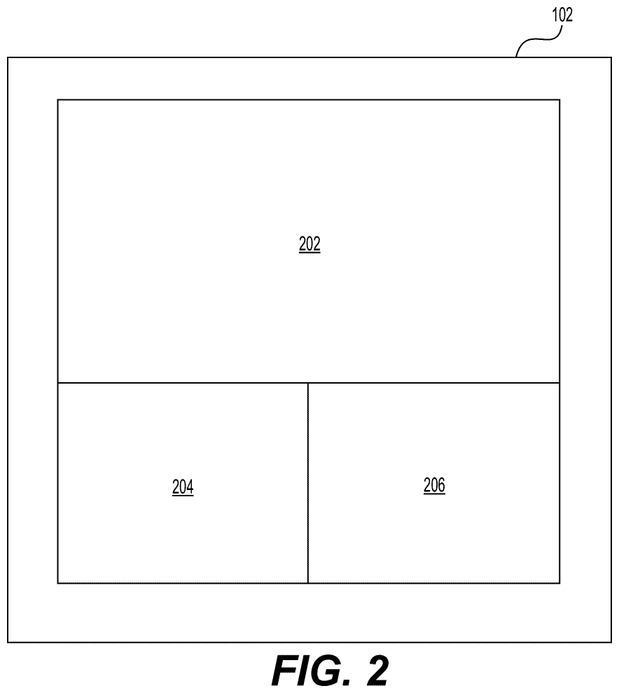

FIG. 2 illustrates a shipping system for a transporting a temperature sensitive material 102, in accordance with various embodiments. In various embodiments, the shipping system for a transporting a temperature sensitive material 102 may comprise a container system 202, a heat transfer system 204, and a condition monitoring system 206. In various embodiments, the container system 202 may include a shipping container and a storage container.

In various embodiments, the heat transfer system 204 and the condition monitoring system 206 may be subcomponents of the shipping container and/or the storage container.

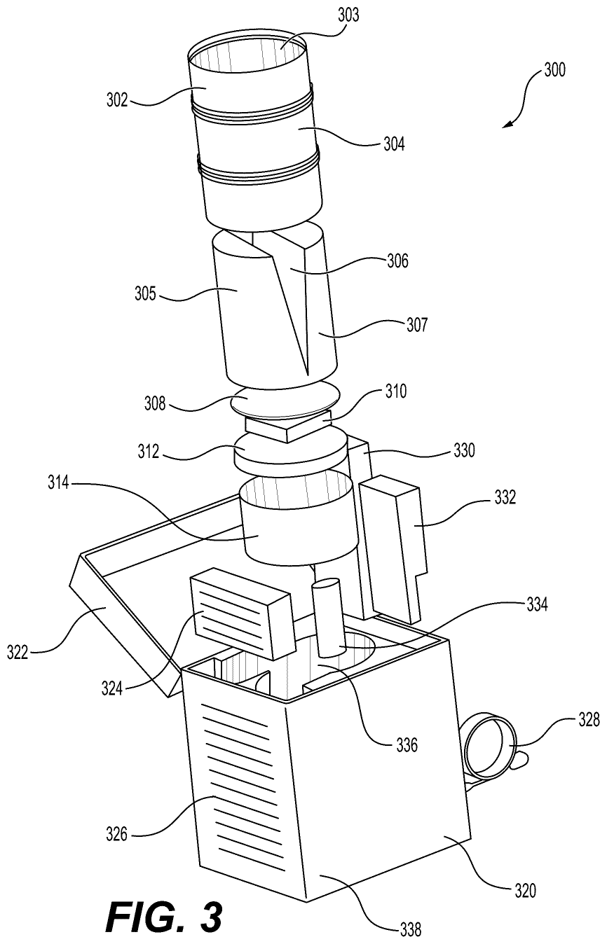

FIG. 3 illustrates a system for transporting a temperature sensitive material 300 in accordance with various embodiments. In various embodiments, the system 300 may comprise a shipping container 320 and a storage container 302. In various embodiments, the shipping container 320 may house the storage container 302, a heat transfer system, and a condition monitoring system. In various embodiments, one or more components of the heat transfer system may be associated with the shipping container 320. In various embodiments, one or more components of the heat transfer system may be associated with the storage container 302. The various systems may require electrical components (e.g., electrical wiring, wireless adapters, etc.) The systems may require fluidic components (e.g., channels or tubing for circulating a coolant).

In various embodiments, the shipping container 320 may comprise a housing 338 surrounding one or more cavities 336 for receiving one or more components of the storage container 302, heat transfer system, and/or the condition monitoring system. In various embodiments, the components of the system may be designed to house a temperature sensitive material (e.g., a food, a beverage, an aphoresis material, or an organic compound) and to monitor and maintain a temperature of the temperature sensitive material. In various embodiments, the one or more cavities 336 are shaped to accept a storage container 302. For example, in embodiments when a storage container 302 is substantially cylindrical then at least one cavity 336 may include a cylindrical profile.

In various embodiments, a storage container 302 may include a housing 338 designed to help maintain an internal temperature that is colder than an ambient temperature. In various embodiments, the shipping container 320 may include a lid 322 designed to enclose one or more cavities 336 of the shipping container 320. An example of a storage container 302 may include a dewar or flask. In various embodiments, the dewar may be formed from a doubled walled housing 304 and a space between the two walls may be a vacuum or comprise a material resistant to heat transfer.

In various embodiments, the storage container 302 may include an internal cavity 303 surrounded by a double walled housing 304. In various embodiments, an insert 305 may be sized to fit into the internal cavity 303 of the storage container 302. In various embodiments, the insert 305 may include an opening 306 for receiving a container or bag holding an apheresis material.

In various embodiments, the storage container 302 may comprise a vacuum flask. In various embodiments, the storage container 302 may comprise a Dewar flask, Dewar bottle, and/or a thermos.

In various embodiments, the storage container 302 may comprise a first flask placed inside of a second flask and the first flask and the second flask may be joined a neck region. In various embodiments, a gap or open space may exist between the first flask and the second flask. In various embodiments, the gap or open space may be evacuated of air, thereby creating a vacuum or partial vacuum.

In various embodiments, an exterior surface of the double walled housing 304 may be silvered to reduce heat transfer by thermal radiation. In various embodiments, silvering may include the use of any suitable substance for silvering (e.g., a reflective metal).

In various embodiments, the storage container 302 may act to reduce heat transfer between an external environment and the internal cavity 303 of the storage container 302. In various embodiments, the storage container 302 may reduce heat transfer by conduction. In various embodiments, the storage container 302 may reduce heat transfer by convention.

In various embodiments, an insert 305 may include a phase change material. In various embodiments, the insert 305 may include a wall 307 that encloses or partially encloses a compartment. In various embodiments, a portion of the wall 307 may abut the housing 304 of the storage container 302 and a bag containing an apheresis material may fit into the opening 306 and be in physical contact with a portion of the wall 307 when in use. In various embodiments, the compartment may contain a phase change material. In this example, the insert 305 may function as a vessel for containing a phase change material.

In various embodiments, an insert 305 may be sized and shaped to accommodate a container (e.g., a bag) holding an apheresis material. For example, in various embodiments, the insert 305 may resemble the shape of a storage container 302 such that the cylindrically shaped side walls of the insert 305 may fit into the storage container 302. In various embodiments, the insert 305 may include an opening 306 formed to a receive a container or bag holding an apheresis material. For example, a “wedge” shaped opening may allow a bag or container to slide into the insert 305 and have its side walls abut the wall 307 of the insert 305 forming the opening 306.

In various embodiments, a profile of an insert 305 may be substantially cylindrical shaped and include a first end 398 and an opposing second end 399 connected by side walls 307. In various embodiments, an opening 306 may form at the first end 398 of the insert 305 and project toward the second end 399 of the insert 305. In various embodiments, the opening may be larger at the first end of the insert 305 and taper include a portion of the walls 307 meet.

In various embodiments, the insert 305 may include a hollow chamber for holding a phase change material. In various embodiments, the insert 305 may comprise any suitable canister. In various embodiments, the canister may comprise a material resistant to cold temperatures. In other embodiments, the entirety of the insert 305 may be a phase change material.

In various embodiments, a phase change material may comprise one or more substances or compounds having the capacity to absorb and release heat energy when they change phase (e.g., a change between one of a solid, liquid, gas, plasma). In various embodiments, the phase change material may be designed to change phase at a specific temperature.

In various embodiments, the storage container 302 and the insert 305 may be a single contiguous piece of material. In other embodiments, the storage container 302 may resemble a double walled vacuum flask and the insert may benefit from heat transfer properties of the vacuum or lack thereof.

In various embodiments, the system 300 may be designed to maintain the temperatures of the phase change material. In such embodiments, a heat transfer system may be used for removing heat from the phase change material. In various embodiments, a portion of a heat transfer system (e.g., a chill plate) may be in physical contact with an insert 305. In various embodiments, the chill plate 308 may facilitate heat transfer away from the insert 305.

In various embodiments, a chill plate 308 may be in thermal contact with a phase change material. In various embodiments, the chill plate 308 may be in physical contact with an insert 305. In various embodiments, the chill plate 308 may be in physical contact with the second end 399 of the insert 305.

In various embodiments, a chill plate 308 may be in in physical and/or thermal contact with a heat exchanger 310. In various embodiments, the chill plate 308 may be designed to remove heat from the insert 305 and transfer it to the heat exchanger 310.

In various embodiments, a heat exchanger 310 may house one or more thermoelectric coolers (TECs). In various embodiments, thermoelectric cooling may take advantage of the Peltier effect to create heat flux at the junction between two different materials. In various embodiments, one or more TECs may be used to lower the temperate of the phase change material. In some embodiments, one or more TECs may be used to increase the temperature of the phase change material.

In various embodiments, the system may operate without a phase change material. For example, one or more TECs may operate continuously or semi-continuously to maintain a temperature of a biological material (e.g., an apheresis material) by transferring heat away from the biological material directly or through one or more intermediaries that may be thermally coupled to the one or more TECs. For example, the one or more TECs may be configured to interact with a housing of the storage container, an insert, or another component in thermal communication with the one or more TECs.

In various embodiments, the heat exchanger 310 may be thermally or fluidically coupled to a radiator 324 by one or more channels or hoses. In various embodiments, the one or more channels or hoses may be designed to transfer a coolant between the heat exchanger 310 and the radiator 324.

In various embodiments, a heat exchanger 310 may be mounted to a chill plate 308. In various embodiments, the heat exchanger 310 may be designed to dissipate heat from the chill plate 308. In various embodiments, the heat exchanger 310 comprises one or more channels for flowing a fluid (e.g., a liquid) and/or facilitating heat dissipation.

In various embodiments, the system 300 may comprise a radiator 324. In various embodiments, the radiator 324 may be thermally coupled to the heat exchanger 310. In various embodiments, the heat exchanger 310 and the radiator 324 may be thermally coupled by a fluid channel. In various embodiments, the system may comprise a pump for pumping a fluid through a fluid channel. In various embodiments, the fluid channel may comprise one or more channels that fluidically couple the heat exchanger 310 to the radiator 324.

In various embodiments, a system may include a heat sink 312. In various embodiments, the heat sink 312 may be in physical contact with a heat exchanger 310. In various embodiments, the heat sink 312 may act to remove heat from the chill plate 308 and/or heat exchanger 310.

In various embodiments, a radiator 324 may be positioned within a shipping container 320. In various embodiments, the radiator 324 may be positioned near one or more vents 326 or openings of the shipping container 320 housing. In various embodiments, heat may be transferred from the phase change material to an ambient environment using a heat transfer system including one or more chill plates 308, heat exchangers 310, and/or heat sinks 312, and in any combination.

In various embodiments, a heat transfer system may include a housing 314 for positioning one or more of the components (e.g., phase change material, chill plate(s), heat exchanger(s), heat sink(s), etc.) for the heat transfer system relative to one another. For example, a heat transfer system housing 314 may position a chill plate 308 in a position proximate and relative to a heat exchanger 310. In various embodiments, a heat transfer system housing 314 may position a heatsink 312 in a position relative to the chill plate 308 and/or heat exchanger 310. In various embodiments, a heat transfer system housing 314 may ensure thermal communication between the chill plate 308, the heat exchanger 310, and the heat sink 312.

In various embodiments, a shipping container 320 may be designed to house one or more batteries 330, a controller 332, and a data logger 334.

In various embodiments, the system 300 may comprise a control system. In various embodiments, the control system may include a power supply 330, a controller 332, and a sensor.

In various embodiments, a sensor may be in thermal communication with a phase change material. In various embodiments, the sensor may be in physical contact with the phase change material. In various embodiments, the sensor may be in physical contact with a chill plate 308, a heat exchanger 310, and/or a heat sink 312.

In various embodiments, the system 300 may comprise one or more thermal electric coolers (TECs). In various embodiments, the one or more thermal electric coolers may assist in transferring heat from the internal cavity 303 of the storage container 302 and/or its contents. For example, in various embodiments the heat exchanger 310 may comprise one or more thermal electric coolers. In various embodiments, the chill plate 308 may comprise one or more thermal electric coolers.

In various embodiments, the controller may be in electronic communication a power supply 330 and the power supply 330 may provide electricity to the thermal electric cooler(s) and/or other components of the system.

In various embodiments, the controller 332 may be programmed with a feedback loop. In various embodiments, the feedback loop may be configured to compare a temperature reading from the sensor to a setpoint temperature.

In various embodiments, when the temperature reading goes above the setpoint the controller 332 may activate the power supply 330 to power the one or more thermal electric coolers. Once powered, the thermal electric coolers may then work to decrease the temperature of the phase change material.

In various embodiments, a controller 332 includes a display. In various embodiments, the display may show status information. For example, status information may include an on/off indicator, a sensor measurement, a power level for the power supply, etc. In various embodiments, the display may include a touchscreen. In various embodiments, the system may comprise an on/off switch or button. In various embodiments, the on/off switch may be integrated into the touchscreen. In other embodiments, the on/off switch may be separate from the touchscreen.

In various embodiments, a power supply 330 may be charged via a power cable 328 extending away from the housing of the shipping container 320. In various embodiments, the power cable may bypass the power supply 330 to provide direct power to a heat transfer system (e.g., one or more thermal electric coolers). In various embodiments, the power cable may provide direct power the heat transfer system during an initial startup process for cooling a phase change material to a target temperature prior to the system receiving an apheresis material. In various embodiments, the power supply 330 may be used to power the heat transfer system during transport when no external power source is available. In various embodiments the power supply may be powered via one or more onboard batteries. In various embodiments, the one or more batteries may be located within housing of the shipping container 320. In various embodiments, the one or more batteries may be housed exterior to the housing of the shipping container. In various embodiments, the batteries may provide electrical current to each of the systems described herein. In various embodiments the battery may use a power cable to recharge between uses. In various embodiments, the battery may initiate cooling. In various embodiments, a power cord may be unnecessary to begin a cooling cycle.

In various embodiments, a controller 332 may be in electronic communication with one or more sensors. For example, one or more sensors may be positioned near or within the phase change material for measuring a temperature of the phase change material. In various embodiments, if the phase change material goes above a predetermined temperature, the controller 332 may provide instructions to power supply 330 to power the heat transfer system to cool down the phase change material.

The various systems described herein may include an environmental condition monitoring system. In various embodiments, an environmental condition monitoring system may comprise a data logger 334 and one or more sensors. In various embodiments, a data logger 334 may include one or more sensors for monitoring one or more environmental conditions associated with a temperature sensitive material (e.g., an apheresis material) during transport. For example, the data logger 334 can monitor a temperature associated with the apheresis material in real time. In various embodiments, the data logger 334 may include a transmitter for sending temperature information over a wireless network to a user. In various embodiments, the sensor may include a thermocouple in physical contact with the phase change material and/or canister for taking periodic temperatures measurements.

In various embodiments, the data logger 334 may comprise a computer system. In various embodiments, the data logger 334 may comprise a transmitter. An example of a transmitter may include a wireless adaptor for connecting to wireless networks. Another example of a transmitter may include a cell phone service adapter for accessing cell phone towers. In various embodiments, the data logger 334 may use the transmitter to send signals to a user about the environment within the shipping container (e.g., a temperature of a phase change material).

In various embodiments, any kind of sensor may be suitable for the environmental condition monitoring system. In various embodiments, the sensor may comprise a thermocouple.

In various embodiments, the sensor may take continuous measurements. In various embodiments, the sensor may take periodic measurements. For example, measurements may be taken every 1 second, 10 seconds, 30 seconds, 1 minute, 5, minutes, 10 minutes, etc.

In various embodiments, the data logger 334 may communicate with the controller 332.

In various embodiments, a data logger may be responsible for sending other information to a user. For example, a data logger may send a set of global positioning coordinates to a user using a GPS tracking system.

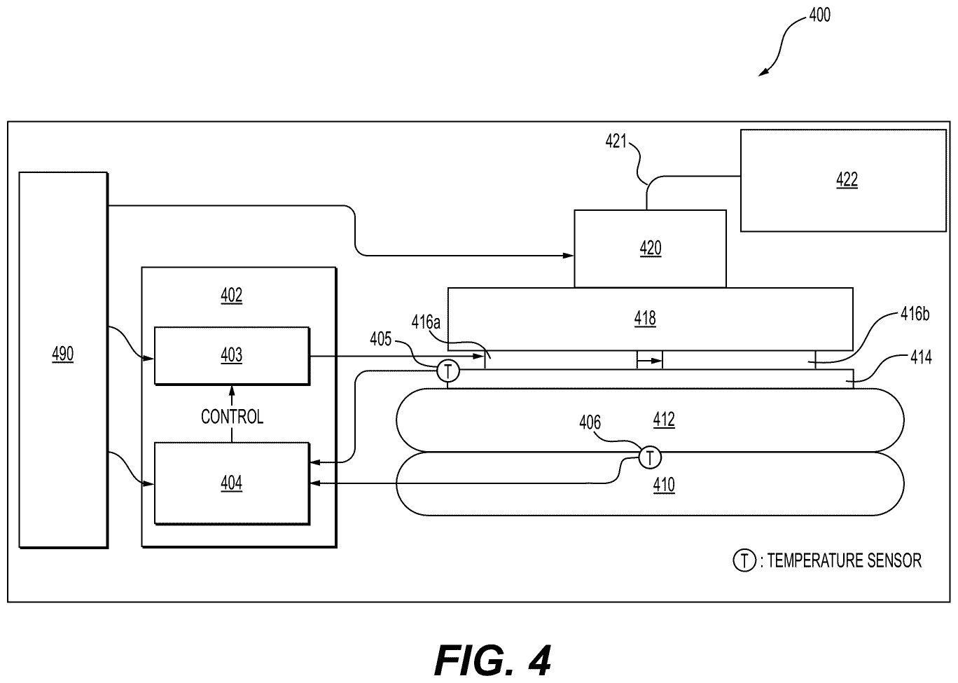

FIG. 4 is a schematic diagram of a heat transfer system 400 for a shipping system (e.g., 102, 300) for transporting a temperature sensitive material, in accordance with various embodiments. A skilled artisan may appreciate that components and connecting elements (e.g., wires, plumbing, etc.) may be arranged differently and that FIG. 4 illustrates an exemplary embodiment.

In various embodiments, the heat transfer system 400 may comprise a control system 402. The control system 402 may include a power supply 403 and a controller 404. In various embodiments, the heat transfer system 400 may comprise a housing for housing the power supply 403 and the controller 404 together as a single unit. In various embodiments, the heat transfer system 400 may comprise a housing for the power supply 403 and a separate housing for the controller 404.

In various embodiments, the controller 404 may be in electronic communication with the power supply 403. In various embodiments, the controller 404 may send instructions to the power supply 403 to modulate power output to the thermal electric cooler(s) 416a, 416b. In various embodiments, the instructions may include on/off. In various embodiments, the instructions may include increasing or decreasing a power output.

In various embodiments, an external power source 490 (e.g., any suitable electrical outlet connected to the electrical grid, battery, generator, solar array, etc.) can charge/rechange the power supply 403 (e.g., a battery such as a lithium ion battery). For example, the shipping system may comprise an electrical cable in a similar fashion to some commercial appliances. In various embodiments the power source may include an onboard battery. In various embodiments, the onboard battery may be charged by an electrical connection to the external power source 490.

In various embodiments, a power supply 403 may be charged prior to being connected to an electrical system of the shipping system. In such embodiments, an external power source 490 may function solely or primarily to charge/recharge the power supply 403. In alternative embodiments, the external power source 490 may be unnecessary. For example, in addition to or alternatively to being charged externally prior to shipping, the power supply 403 may remain housed in the system and charged/recharged wirelessly.

In various embodiments, while the heat transfer system 400 is connected to an external power source 490, the external power source 490 may supply power to the controller 404. In various embodiments, while the heat transfer system 400 is connected to an external power source 490, the external power source 490 may supply power to a heat exchanger 420. In various embodiments, while the heat transfer system 400 is connected to an external power source 490, the external power source 490 may supply power to one or more thermal electric coolers 316a, 316b.

In various embodiments, the heat transfer system 400 may include a phase change material 410, 412. In various embodiments, the heat transfer system 400 includes one or more sensors 406 to monitor an environmental condition of the phase change material 410, 412.

In various embodiments, a phase change material may comprise one or more substances or compounds having the capacity to absorb and release heat energy when they change phase (e.g., a change between one of a solid, liquid, gas, plasma). In various embodiments, the phase change material may be designed to change phase at a specific temperature.

In various embodiments, a sensor 406 may be in thermal contact with the phase change material 410, 412. In various embodiments, the sensor 406 may be in physical contact with the phase change material 410, 412.

In various embodiments, the sensor 406 may measure an environmental condition. In various embodiments, the sensor 406 may measure a temperature of the phase change material 410, 412.

In various embodiments, the sensor 406 may be in electronic communication with the controller 404 and communicate the measured environmental condition (e.g., the temperature).

In various embodiments, the sensor 406 communications any measures it takes back to the controller 404.

In various embodiments, the controller 404 includes a memory. In various embodiments, the memory includes a temperature setpoint that may be used in a feedback loop. In various embodiments, when the measured temperature by the sensor 406 falls below the setpoint by a quantity then the controller 404 may send instructions to the power supply 403 to activate and/or increase power output. In various embodiments, when the measured temperature by the sensor 406 rises above the setpoint by a quantity then the controller 404 may send instructions to the power supply 403 to deactivate or decrease power output.

In various embodiments, the heat transfer system 400 may include a chill plate 414 (sometimes referred to as a “heat spreader”). In various embodiments, the chill plate 414 may be in thermal contact with the phase change material 412. In various embodiments, the chill plate 414 may be in physical contact with the phase change material 412. In various embodiments, there may be an intermediate material between the chill plate 414 and the phase change material 412 that helps facilitate heat transfer.

In various embodiments, a sensor 405 may be in thermal contact with the chill plate 414. In various embodiments, the sensor 405 may be in physical contact with the chill plate 414. In various embodiments, the sensor 405 may measure an environmental condition (e.g., temperature, humidity, etc.). In various embodiments, the sensor 405 may measure a temperature of the chill plate 414.

In various embodiments, the sensor 405 may be in electronic communication with the controller 404 and communicate the measured environmental condition (e.g., the temperature). In various embodiments, the sensor 405 communications any measures it takes back to the controller 404.

In various embodiments, the controller 404 includes a memory. In various embodiments, the memory includes a temperature setpoint that may be used in a feedback loop. In various embodiments, when the measured temperature by the sensor 405 falls below the setpoint by a quantity then the controller 404 may send instructions to the power supply 403 to activate or increase power output. In various embodiments, when the measured temperature by the sensor 405 rises above the setpoint by a quantity then the controller 404 may send instructions to the power supply 403 to deactivate and/or decrease power output.

In various embodiments, the chill plate 414 may be in thermal contact with one or more thermal electric coolers 416a, 416b. In various embodiments, the chill plate 414 may be in physical contact with one or more thermal electric coolers 416a, 416b. In various embodiments, the chill plate 414 may help facilitate heat transfer between the phase change material 412 and the thermal electric coolers 416a, 416b.

In various embodiments, the heat transfer system 400 may include a heat sink 418 (sometimes referred to as a “heat reservoir”). In various embodiments, one or more of the thermal electric coolers 416a, 416b may be in thermal communication with the heat sink 418. In various embodiments, one or more of the thermal electric coolers 416a, 416b may physically abut and/or be housed at least partially within the heat sink 418. In various embodiments, the heat sink 418 may house (e.g., see housing 314) the thermal electric coolers 416a, 416b.

In various embodiments, the heat transfer system 400 may include a heat exchanger 420. In various embodiments, the heat exchanger 420 may be in thermal communication with the heat sink 418. In various embodiments, the heat exchanger 420 may physically abut the heat sink 418.

In various embodiments, the heat sink 418 may serve the purpose of transferring heat away from the thermal electric coolers 416a, 416b and to a heat exchanger 420 for later heat dissipation away from the shipping system.

In various embodiments, the heat transfer system 400 may include a radiator 422. In various embodiments, the heat exchanger 420 and the radiator 422 may be in fluidic communication through a fluid channel. In various embodiments, the fluid channel 421 extends into the heat exchanger 420. In various embodiments, the fluid channel 421 extends into the radiator 422.

In various embodiments, the purpose of the radiator 422 is to move heat away from the heat exchanger 420 and dissipate it into the environment. For example, a coolant may be pumped so that it circulates through the fluid channel 421 to help move heat to the radiator 422.

In various embodiments, the phase change material 410, 412 may be interacting with a temperature sensitive material. In various embodiments, the interaction may involve maintaining the temperature sensitive material to within a range of temperatures. In various embodiments, the temperature range may be significantly below ambient temperatures and the phase change material may act to cool the temperature sensitive material and/or the surrounding environment of the temperature sensitive material.

As described herein, when the heat transfer system 400 when in-use and performing its function (e.g., maintaining or modulating an environmental condition within a storage container), either directly or indirectly, heat may be transferred away from the temperature sensitive material to an external environment using any of the apparatuses, systems and/or methods of use described herein.

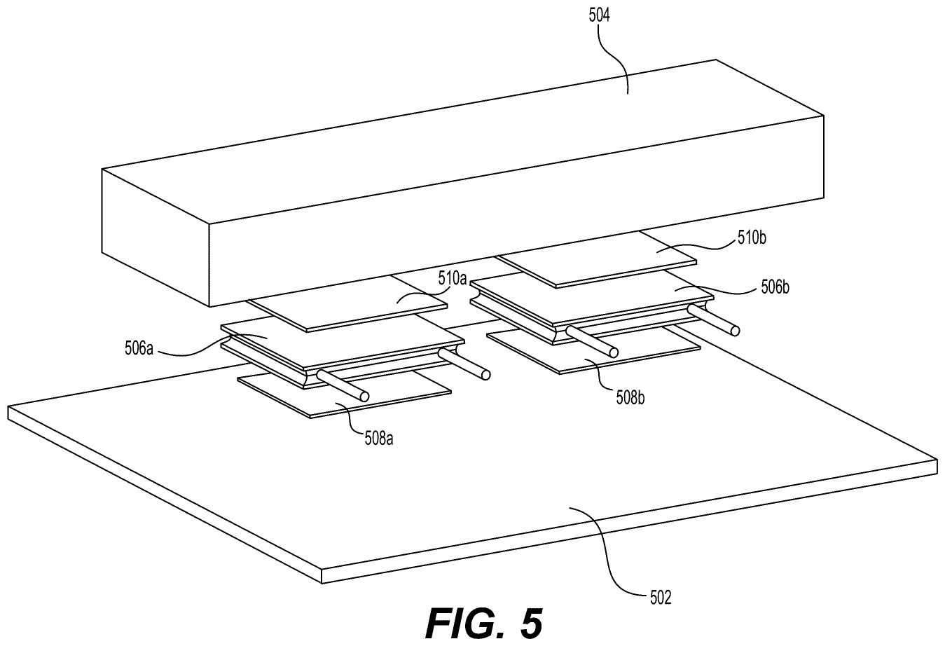

FIG. 5 illustrates an exploded view of components of a heat transfer system for a shipping system for transporting a temperature sensitive material, in accordance with various embodiments.

In various embodiments, a chill plate 502 may be in thermal contact with one or more thermal electric coolers 506a, 506b. In various embodiments, thermal contact may occur through an intermediary material 508a, 508b. In various embodiments, the intermediary material 508a, 508b may include a thermal material.

In various embodiments, a heat sink 504 may be in thermal contact with one or more thermal electric coolers 506a, 506b. In various embodiments, thermal contact may occur through an intermediary material 510a, 510b. In various embodiments, the intermediary material 510a, 510b may include a thermal material.

In various embodiments, intermediary materials 510a, 510b may be used to facilitate efficient transfer of heat. For example, intermediary materials 510a, 510b may be selected for their thermal conductivity properties. An intermediary material 510a, 510b may be selected in order to maximize heat transfer and dissipation between the components it contacts. Non-limiting examples of intermediary material 510a, 510b may include thermal pastes comprising a polymerizable liquid matrix and large volume fractions of electrically insulating, but thermally conductive filler.

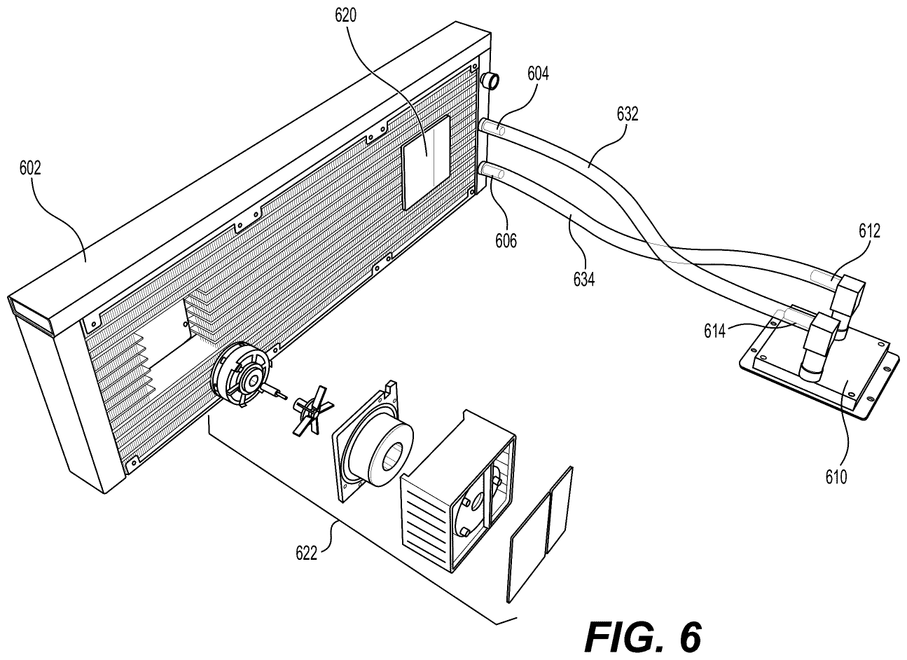

FIG. 6 illustrates a portion of a heat transfer system having fluid channels 632, 634, in accordance with various embodiments. In various embodiments, a fluid may be circulated between a heat exchanger 610 and a radiator 602 through the fluid channels 632, 634.

In various embodiments, a heat exchanger 610 may comprise an inlet 612 and an outlet 614. In various embodiments, the heat exchanger 610 may comprise a housing 613 surrounding a hollow interior for following a fluid. In various embodiments, the inlet 612 and the outlet 614 may be formed from the same or a different piece of material as the housing 613.

In various embodiments, a heat exchanger 302 may comprise a housing surrounding the hollow portion and the inlet 321 and the outlet 322 provide external access to the hollow portion. In some embodiments, the hollow portion may resemble the internal structure of a commercially available radiator or heat exchanger. In various embodiments, the inlet 321 may direct a fluid from a radiator into the hollow portion. In various embodiments, the outlet 322 may director a fluid out of the hollow portion and to the radiator.

In various embodiment, the hollow portion may comprise a straight pathway and be formed by a piece of tubing. In various embodiment, the hollow portion may comprise one or more bends and be formed by one or more curved pieces of tubing connected to the straight piece of tubing. In various embodiment, the hollow portion may comprise a chamber and the inlet 612 and the outlet 614 may be positioned on opposite ends of the chamber. In various embodiments, the chamber may comprise a serpentine shape. In various embodiments, the inlet 612 and the outlet 614 may be positioned anywhere on the chamber.

In various embodiments, the hollow portion contains the hottest fluid of the system because the heat exchanger 610 may be in thermal contact with a heat sink.

In various embodiments, fluid can exit the heat exchanger 610 through the outlet 614 and be transported to an inlet 604 of the radiator 602 through a fluid channel 634. As fluid circulates through the radiator 602 heat can dissipate into the surrounding environment.

Fluid may exit the radiator 602 through an outlet 606 and enter the inlet 612 of the heat exchanger 610, in accordance with various embodiments.

In various embodiments, one or more pumps 620, 622 may be responsible for circulating fluid through the system shown in FIG. 6. In various embodiments, the pump 620 may include housing and/or one or more panels. In various embodiments, a pump 622 may be constructed from one or more components (see exploded view of pump).

In various embodiments, a fluid may comprise a coolant. Non-limiting examples of coolant may include water, ethylene glycol, and propylene glycol.

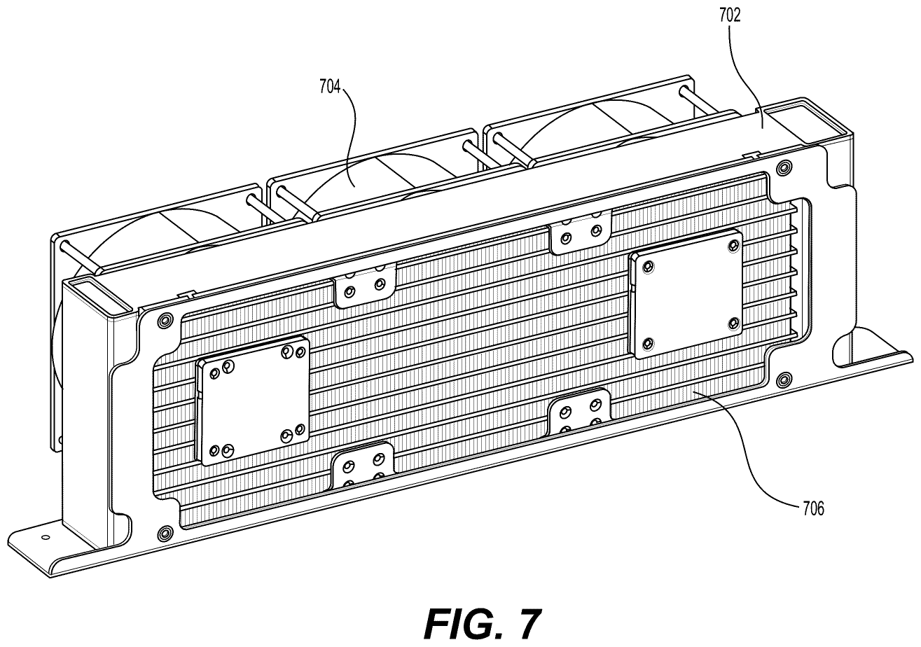

FIG. 7 illustrates a radiator 702 for a heat transfer system, in accordance with various embodiments. In various embodiments, fluid moves through internal radiator channels (not shown) and fins 706 extend away from the channels. Typical channels comprise tubing or piping commonly used in currently available radiators. Hot fluid may circulate through the internal radiator channels, thereby, heating the material enclosing the channels. Fins 706 coming off the channels are visible on the radiator 702 shown in FIG. 7. The fins 706 may be thermally coupled to the channel. In various embodiments, heat in the fluid passes out of the channel, into the fins 706, and radiates into an external environment. In various embodiments, one or more fans 704 blow air over radiator the fins 706 to facilitate heat dissipation. In various embodiments, the one or more fans 704 blow hot air outside of a shipping container and pull cool air into the shipping container or vice versa.

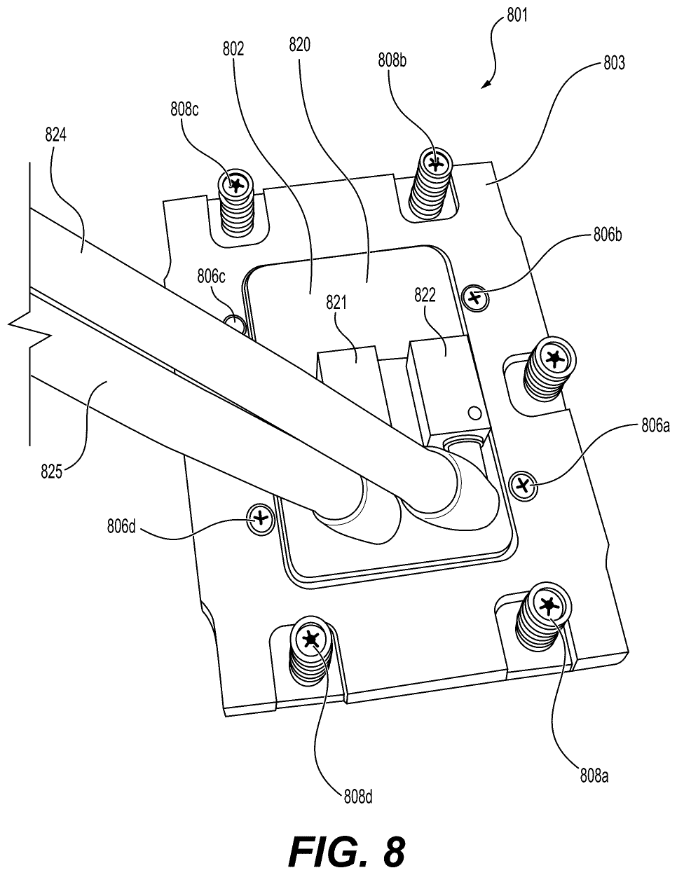

FIG. 8 shows a heat exchanger 802 mounted to a heat sink 801, in accordance with various embodiments. As heat begins to transfer from the thermal electric cooler(s) to the heat sink 301, the heat exchanger 302 in thermal proximity with the heat sink 301 may remove heat with the assistance of a circulating coolant, radiator, and fan system such as the ones described herein, in accordance with various embodiments.

In various embodiments, the heat exchanger 802 may comprise a housing 820 that surrounds a hollow portion. In various embodiments, the purpose of the hollow portion may be to flow a coolant fluid through it, thereby transferring heat from the heat sink 801 through a thermal paste or substitute material, into the housing of the heat exchanger 802 where heat can move to the coolant for later dissipation into an external environment.

In various embodiments, a fluid may flow through the hollow portion from an inlet 821 to and outlet 822. In various embodiments, the inlet 821 may be fluidically coupled to a radiator through a fluid channel 825. In various embodiments, the outlet 822 may be fluidically coupled to a radiator through a fluid channel 824.

In various embodiments, the housing 820 of the heat exchanger 802 may be coupled to the heat sink 801. Coupling may be done using any known method. Non-limiting examples of attachment elements used to couple may include weld, adhesive, nail, screw, tack, pin, etc.

In various embodiments, a mounting bracket 803 may be used to help facilitate coupling of the heat exchanger 802 to the heat sink 803. In various embodiments, one or more attachment elements 808a, 808b, 808c, 808d may couple the mounting bracket 803 to the heat sink 803. In various embodiments, one or more attachment elements 806a, 806b, 806c, 806d may couple the mounting bracket 803 to the heat exchanger 802.

In various embodiments, one or more of the attachment elements 806a, 806b, 806c, 806d, 808a, 808b, 808c, 808d comprise a no-tool release mechanism. Such a mechanism may enable users of any knowledge level to connect and disconnect the heat exchanger 802 to the heat sink 801.

In various embodiments, the mounting bracket 803 may include a lip and the housing 820 of the heat exchanger 802 may include an opposing lip. In various embodiments, the lips can be welded together. In various embodiments, the lips may include opposing openings such that a screw, screw and not assembly, bolt, pin, nail, tack may interact with the openings to couple the heat exchanger 802 to the mounting bracket 803. In various embodiments, a mounting bracket may include at least one opening that is sized to allow the body of a screw extend through the mounting bracket 803 and interact with threads on a perimeter of at least one opposing opening on the housing 820 of the heating exchanger 802.

The example shown and described allows for case of connecting and disconnecting a shipping container from a storage container where the radiator may be mounted to a housing of the shipping container and the heat sink may be part of a dewar assembly/storage container. As explained herein, a disadvantage in the industry involves the difficulty and startup and winddown which include complicated connection systems (e.g., electrical wiring and plumbing between a storage container and a shipping container). The examples described and shown herein may allow case of use such that hospital staff, clinical staff, and other users may be entrusted with the startup and winddown procedure.

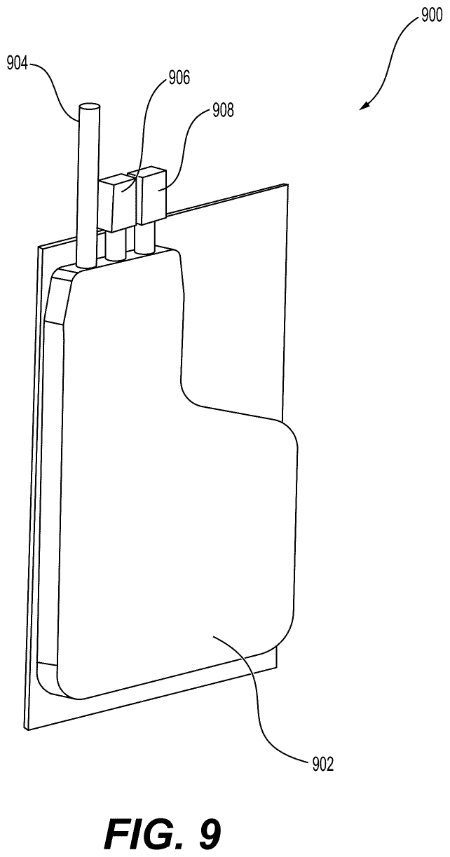

FIG. 9 shows a bag 900 for transporting a temperature sensitive material in accordance with various embodiments. For example, the bag 900 may be positioned into an opening of an insert as described herein. In various embodiments, the bag 900 may comprise an inlet 906 fluidically coupled to a compartment 902. In various embodiments, the bag 900 may comprise an outlet 908 fluidically coupled to the compartment 902. In various embodiments, the bag 900 may comprise an air vent 904 that connects the compartment 902 to atmosphere.

In various embodiments, a material selected for the compartment 902 and/or bag 900 may be based on preventing toxicity or optimizing hospitable conditions for the temperature sensitive materials described herein. In various embodiments, at least some of the material may include one or more layers of film polymer.

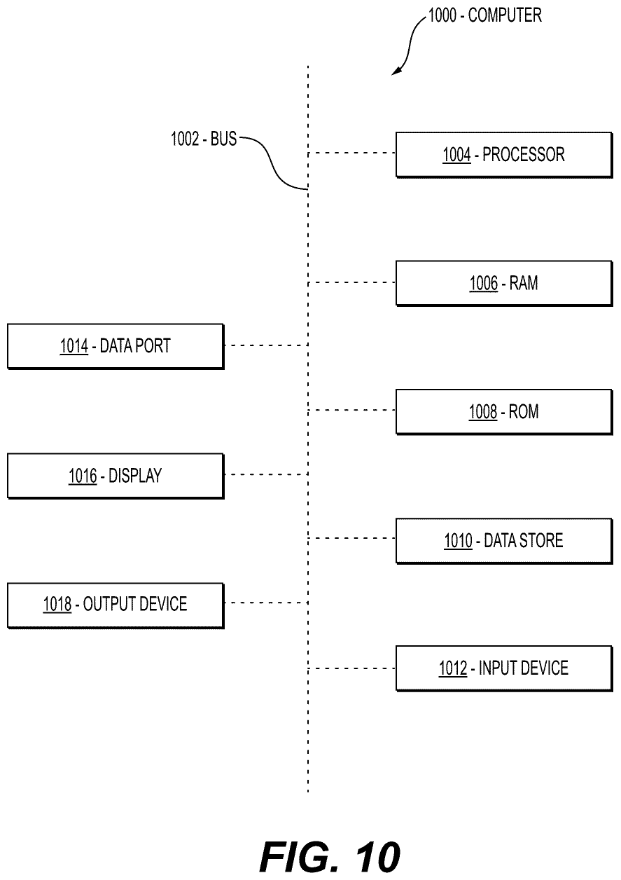

FIG. 10 is a schematic diagram of a computer system 1000 in accordance with various embodiments. The computer system 1000, upon which embodiments of the present teachings may be implemented. In various embodiments, a computer system 1000 may be integrated into other parts of the system. For example, a controller, a data logger, a cell phone tower, a user device, or almost any other aspect of the system may include an integrated computer system 1000. Non-limiting functions of a computer system 1000 may include operation of processes (e.g., feedback loops) described herein, processing data received from sensors, providing communication between systems and operators, providing digital storage, etc.

In various embodiments of the present teachings, computer system 1000 may include a bus 1002 or other communication mechanism for communicating information, and a processor 1004 coupled with bus 1002 for processing information. In various embodiments, computer system 1000 may also include a memory, which can be a random-access memory (RAM) 1006 or other dynamic storage device, coupled to bus 1002 for determining instructions to be executed by processor 1004. Memory also can be used for storing temporary variables or other intermediate information during execution of instructions to be executed by processor 1004. In various embodiments, computer system 1000 may further include a read only memory (ROM) 1008 or other static storage device coupled to bus 1002 for storing static information and instructions for processor 1004. A data store 1010, such as a magnetic disk or optical disk, can be provided and coupled to bus 1002 for storing information and instructions.

In some embodiments, computer system 1000 can be coupled via bus 1002 to a display 1016, such as a cathode ray tube (CRT), liquid crystal display (LCD), or light emitting diode display (LED) for displaying information to a computer user. An input device 1012, including alphanumeric and other keys, can be coupled to bus 1002 for communicating information and command selections to processor 1004. Another type of user input device 1012 is a cursor control, such as a mouse, a trackball or cursor direction keys for communicating direction information and command selections to processor 1004 and for controlling cursor movement on display 1016. In various embodiments, the computer system 1000 may include a touchscreen display. The input device 1012 typically has two degrees of freedom in two axes, a first axis (i.e., x) and a second axis (i.e., y), that allows the device to specify positions in a plane. However, it should be understood that input devices 1012 allowing for 3-dimensional (x, y and z) cursor movement are also contemplated herein.

In various embodiments, computer system 1000 can be coupled via bus 1002 to one or more data ports 1014. In various embodiments, the one or more data ports 1014 may enable electronic communication between the components via bus 1002 of the computer system 1000 and other components of the overall system described herein.

Consistent with certain implementations of the present teachings, results can be provided by computer system 1000 in response to processor 1004 executing one or more sequences of one or more instructions contained in memory 1006. Such instructions can be read into memory 1006 from another computer-readable medium or computer-readable storage medium, such as a storage device containing information relating to environmental control (e.g., a feedback algorithm) or an environmental condition monitoring system. Execution of the sequences of instructions contained in memory 1006 can cause processor 1004 to perform the processes described herein. Alternatively, hard-wired circuitry can be used in place of or in combination with software instructions to implement the present teachings. Thus, implementations of the present teachings are not limited to any specific combination of hardware circuitry and software.

According to various embodiments, computer-readable medium (e.g., data store, data storage, etc.) or computer-readable storage medium may comprise any media that participates in providing instructions to processor 1004 for execution. Such a medium can take many forms, including but not limited to, non-volatile media, volatile media, and transmission media. Non-limiting examples of non-volatile media can include optical, solid state, and magnetic disks, such as 1008. Examples of volatile media can include, but are not limited to, dynamic memory, such as memory 1006. Examples of transmission media can include, but are not limited to, coaxial cables, copper wire, and fiber optics, including the wires that comprise bus 1002.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 1004 of computer system 1000 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, etc. In various embodiments, output devices 1018 such as printers and displays may be used to present output files generated by the processes described herein. Output devices 1018 may be used to communicate real time environmental conditions or a history of environmental conditions. Output device 1018 may be used to indicate the condition or one or more metrics associated with the condition of an apheresis material within the system described herein.

### III. Exemplary Methods

In various embodiments, a variety of methods may be executed on or using the systems and apparatuses described herein. Methods may relate to use of the shipping container and storage container system. Non-limiting examples of unique methods include those related to start-up, sample loading, environmental control, environmental condition monitoring, sample unloading, and system shutdown.

In various embodiments, a user may begin recharging an onboard battery by plugging a cable extending away from the housing of the shipping container into a wall outlet. Electricity may be required for powering a control system and an environmental condition monitoring system for the shipping container. In various embodiments, the system may include multiple batteries. For example, the system may comprise a primary battery and a secondary battery. In various embodiments, the secondary battery may be electrically connected to the primary battery and the secondary battery may be used to recharge the primary battery. In various embodiments, the one or multiple batteries may be housed within the shipping container. In various embodiments, the control system may be responsible for maintaining one or more environmental conditions (e.g., temperature). In various embodiments, the environmental condition monitoring system may be responsible for collector sensor data and transmitting it to a user over a network.

### EQUIVALENCE

Those skilled in the art will recognize or be able to ascertain using no more than routine experimentation, many equivalents to the specified embodiments of the technologies described herein. It is to be understood that the technologies encompass all variants, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise. Further, it should also be understood that any embodiment or aspect of the technologies can be explicitly excluded from the claims, regardless of whether the specific exclusion is recited in the specification.

1. A system for transporting a temperature sensitive material comprising:
a shipping container comprising:
a housing surrounding a cavity; and
a lid for sealing the cavity;
a storage container sized to reside within the cavity, comprising:
a housing enclosing an internal cavity, wherein the housing includes an exterior wall joined to an interior wall forming a vacuum therebetween; and
an insert sized to fit within the internal cavity.

2. The system of claim 1, wherein the insert comprises phase change material.

3. The system of claim 1, wherein the insert comprises:
a first end joined to a second end by a wall; and
an opening extending across the first end and extending toward the second end to form a wedge shape designed for receiving a bag suitable for containing a temperature sensitive material.

4. The system of claim 1, further comprising a chill plate in thermal contact with the insert.

5. The system of claim 4, further comprising at least one thermal electric cooler in thermal contact with the chill plate.

6. The system of claim 5, further comprising a heat sink in thermal contact with the at least one thermal electric cooler.

7. The system of claim 6, further comprising a heat exchanger in thermal contact with the heat sink, wherein the heat exchanger comprises:
a housing surrounding a hollow portion;
an inlet extending away from the housing and providing access to the hollow portion; and
an outlet extending away from the housing and providing access to the hollow portion.

8. The system of claim 7, further comprising:
a mounting bracket, comprising:
a planar element including a top surface joined to a bottom surface by an exterior wall and an interior wall, wherein the interior wall surrounds an opening,
wherein the heat exchanger is positioned within the opening.

9. The system of claim 8, further comprising:
a first set of attachment elements securing the mounting bracket to the heat sink; and
a second set of attachment elements securing the heat exchanger to the mounting bracket.

10. The system of claim 9, further comprising a radiator thermally coupled to the heat exchanger, wherein the radiator comprises:
an inlet;
an outlet connected to the inlet by a flow channel; and
fins positioned within thermal proximity to an exterior surface of the flow channel,
wherein a first fluid channel fluidically connects the inlet of the radiator to the outlet of the heat exchanger,
wherein a second fluid channel fluidically connects the outlet of the radiator to the inlet of the heat exchanger.

11. The system of claim 10, further comprising fans, wherein the fans are positioned adjacent to the fins.

12. The system of claim 11, further comprising a pump positioned along one of the flow channels of the radiator.

13. The system of claim 12, a control system comprising:
a controller in electronic communication with a power supply, wherein the power supply provides electricity to the at least one thermal electric cooler; and
a sensor in electronic communication with the controller, wherein the sensor is thermally coupled to the phase change material.

14. The system of claim 13, further comprising an environmental condition monitoring system comprising:
a data logger; and
a sensor.

15. The system of claim 14, wherein the sensor includes a thermocouple in physical contact with the phase change material.

16. The system of claim 14, wherein the data logger includes a data transmitter.

17. The system of claim 16, wherein the controller and the data logger are in electronic communication.

18. The system of claim 13, wherein the controller includes a user interface.

19. The system of claim 13, wherein the control system comprises an on/off button.

20. The system of claim 10, wherein the housing of the shipping container further comprises vents for dissipating heat from the radiator to an external environment.

21. The system of claim 4, wherein thermal contact may be facilitated by use of thermal paste as an intermediary material.

22. The system of claim 1, wherein the temperature sensitive material comprises an apheresis material.
